(19) United States
(12) Patent Application Publication
(10) Pub. No.: US 2024/0409839 A1
(43) Pub. Date: Dec. 12, 2024

(54) ENHANCED METALWORKING FLUIDS

(71) Applicant: LOCUS SOLUTIONS IPCO, LLC, SOLON, OH (US)

(72) Inventors: LEE SPEIGHT, SOLON, OH (US); ANDREW MORRIS, RICHMOND, VA (US); DANIEL HAGAMAN, MECHANICSVILLE, VA (US)

(21) Appl. No.: 18/248,381

(22) PCT Filed: Mar. 2, 2023
(86) PCT No.: PCT/US2023/014316

§ 371 Date: Apr. 8, 2023

Related U.S. Application Data
(60) Provisional application No. 63/315,747, filed on Mar. 2, 2022.

(51) Int. Cl. C10M 145/40; C09K 23/56; C10N 40/20; C10N 50/00; C10N 70/00

(52) U.S. Cl. CPC C10M 145/40; C09K 23/56; C10M 2201/003; C10M 2201/02; C10M 2207/40; C10M 2209/12; C10N 2040/20; C10N 2050/011; C10N 2070/00

(57) ABSTRACT

The subject invention provides biological emulsifying agents for use in formulating metalworking fluids, methods for formulating the metalworking fluids, and enhanced metalworking fluids.

### CROSS-REFERENCE TO RELATED APPLICATION

This application claims priority to U.S. Provisional Patent Application No. 63/315,747, filed Mar. 2, 2022, which is incorporated herein by reference in its entirety.

### BACKGROUND OF THE INVENTION

During metalworking, a metal may be forged, rolled, stamped, cured, formed or ground into objects ranging from screws to large beams. Metalworking fluids (MWF) are used to reduce heat and friction, and to remove metal particles, in industrial machining and grinding operations. MWFs can be oil- or water-based fluids comprising, for example, mixtures of oils, emulsifiers, detergents, anti-weld agents, corrosion inhibitors, pressure additives, buffers, biocides and other additives. For each manufacturing job, the metalworking fluid must be chosen to meet the demands of a specific application.

The major types of MWF include, first, straight oils, which are non-diluted mineral, animal, marine, vegetable or synthetic oils. Second are soluble oils, which include about 30-85% refined oils and emulsifiers for dispersing the oil in water. Other types include semi-synthetic fluids, which contain a portion of refined petroleum oils, about 30 to 50% water, and a number of other additives; and synthetic fluids, which do not contain oils, but instead use water-soluble materials, such as detergent components and other additives to cool and lubricate.

For soluble oils in particular, an oil/water (0/W) emulsion is formed, which utilizes the lubricity of oil and the cooling properties of water to deliver the desired MWF functions. The stability of the O/W emulsion is key to the success of the formulation; accordingly, an emulsifier is a key additive. Typically, emulsifiers are surface active agents that facilitate the formation and stabilization of emulsions by reducing the interfacial tension between the aqueous and oil phases of the fluid. The chemical structure of an emulsifier is preferably such that it contains functional groups that are compatible with both the aqueous and oil-based phases of the MWF. Emulsifiers in current use include, for example, triethanolamine, sodium petroleum sulphonates, alkoxylated phosphate-esters, alkyl aryl ethoxylates, alcohol alkoxylates, fatty acid ethoxylates, ether-carboxylates and amine ethoxylates.

During use, MWFs become mixed with metal grains, particulate matter, microorganisms and other contaminants. Workers in machine finishing, machine tooling and other metalworking and metal-forming operations can be exposed to MWFs and the contaminants mixed therein through inhalation of aerosols generated in the process, or through skin contact when handling parts, tools and equipment covered with the fluids. This can lead to pathological lung conditions and dermatologic irritation, with long-term exposure potentially being associated with some types of cancer. Ethoxylates, in particular, contain 1,4-dioxane as an impurity, which is a suspected carcinogen.

While protective gear, such as masks, gloves, aprons, and special clothing are important safety precautions, as well as measures such as training workers and modifying machinery to prevent excessive contact with MWFs, improved ingredients and formulations are needed to reduce the negative impact of these fluids on workers and the environment.

### BRIEF SUMMARY OF THE INVENTION

The subject invention relates to improved metalworking fluids (MWFs) comprising oil-in-water or water-in-oil emulsions. More specifically, the subject invention provides novel emulsifiers for formulation of stable MWF emulsions, as well as MWF formulations comprising the same. Preferably, the emulsifier is a biological surface-active agent, or a derivative thereof, which can be used for replacing, for example, ethoxylated surfactant emulsifiers, in MWF applications. Advantageously, in some embodiments, the biological emulsifiers can be up to 100% bio-based and biodegradable, can have low toxicity, and/or can perform at or above the level of traditional emulsifiers and surfactants.

In preferred embodiments, the subject invention provides a microbe-derived surface-active agent that serves a variety of purposes in metalworking. In some embodiments, the surface-active agent serves as an emulsifier, a dispersant, a detergent, a de-foamer and/or a biocide ingredient in a MWF formulation. In certain preferred embodiments, the biological surface-active agent serves as an emulsifier for MWFs comprising O/W and/or W/O emulsions.

Advantageously, in certain embodiments, the biological emulsifier facilitates the formation of MWF emulsions by dispersing water-miscible oil in an aqueous fluid; improves the stability of the emulsion; and/or prevents the demulsification and/or settling out of the oil and water phases, all without negatively altering the function of the MWF.

In preferred embodiments, the biological emulsifier is a biosurfactant or biopolymer including, for example, glycolipids, lipopeptides, flavolipids, phospholipids, fatty acid esters, and high-molecular-weight biopolymers such as lipoproteins, lipopolysaccharide-protein complexes, and/or polysaccharide-protein-fatty acid complexes. In some embodiments, more than one of these can be used at a time.

In one embodiment, the biosurfactants are glycolipids such as, for example, sophorolipids (SLP), rhamnolipids (RLP), cellobiose lipids, trehalose lipids or mannosylerythritol lipids (MEL). In one embodiment, the biosurfactants are lipopeptides, such as, for example, surfactin, iturin, fengycin, arthrofactin, viscosin and/or lichenysin. In one embodiment, the surface active agents are other types of amphiphilic molecules, such as, for example, esterified fatty acids, cardiolipins, emulsan, lipomanan, alasan, and/or liposan.

In a specific embodiment, the biological emulsifier is a sophorolipid or a derivatized SLP molecule. The SLP can comprise a mixture of molecular structures, for example, lactonic SLP, linear SLP, de-acetylated SLP, mono-acetylated SLP, di-acetylated SLP, esterified SLP, SLP with varying hydrophobic chain lengths, SLP with fatty acid-amino acid complexes attached, and others, including those that are and/or are not specifically exemplified within this disclosure.

In a specific preferred embodiment, the biosurfactant is a derivatized SLP, or a mixture of derivatized SLP, wherein the molecular structure of the SLP molecule(s) has been altered to produce a SLP molecule having a higher tolerance for pH instability, high heat and high pressure environments, such as those encountered in some metalworking applications, and/or enhanced de-foaming properties, compared with other SLP molecules.

In certain embodiments, the subject invention provides methods for producing and/or enhancing the stability of MWFs comprising O/W emulsions and W/O emulsions, wherein the method comprises mixing an oil in an aqueous fluid in the presence of a biological emulsifier according to the subject invention.

In some embodiments, the method comprises adding the biological emulsifier to an O/W or W/O emulsion that is already formed in order to enhance the stability of the emulsion or prevent destabilization of the emulsion.

In certain embodiments, enhanced MWF compositions are provided, wherein the composition comprises an oil, an aqueous fluid, and a biological emulsifier according to the subject invention. In certain embodiments, the oil is a petroleum-based oil, a mineral oil, an animal-derived oil, a plant-derived oil, or a synthetic oil. The oil can be present at, for example, from 30 to 90%, or from 25 to 85% relative to the total volume of the MWF.

In some embodiments, the MWF composition can comprise other additives, including, for example, detergents, anti-weld agents, corrosion inhibitors, pressure additives, buffers, biocides and others. In some embodiments, the biological emulsifier also serves one or more of these additional purposes.

Advantageously, the present methods are safe for use in the presence of metalworkers without causing harm to users and without releasing large quantities of polluting and toxic compounds into the environment. Furthermore, the compositions and methods utilize components that are biodegradable and toxicologically safe. Thus, the present invention can be used in a variety of industries as a “green” additive for MWFs.

### DETAILED DESCRIPTION

The subject invention relates to improved metalworking fluids (MWFs) comprising oil-in-water or water-in-oil emulsions. More specifically, the subject invention provides novel emulsifiers for formulation of stable MWF emulsions, as well as MWF formulations comprising the same. Preferably, the emulsifier is a biological surface-active agent, or a derivative thereof, which can be used for replacing, for example, ethoxylated surfactant emulsifiers, in MWF applications. Advantageously, in some embodiments, the biological emulsifiers can be up to 100% bio-based and biodegradable, can have low toxicity, and can perform at or above the level of traditional emulsifiers and surfactants. Furthermore, in some embodiments, the biological emulsifiers can withstand increased heat and pressure environments, such as those encountered in some metalworking applications, and can further be used for reducing foam.

### Selected Definitions

As used herein, the term “emulsion” refers to a type of mixture comprising two immiscible liquid phases, wherein one of the liquid phases (dispersed phase) is divided into small particles or droplets dispersed throughout the other liquid phase (continuous phase). Typically, one of the liquids is a lipid or oil and one is water-based, where either the oil is suspended in the water (oil-in-water, O/W) or the water is suspended in the oil (water-in-oil, W/O). Most emulsions contain dispersed droplets with a diameter of about 1 nm to about 1 m, or greater, about 10 nm to about 500 nm, or about 100 nm to about 250 nm.

As used herein, the term “dispersion” refers to solid primary particles, agglomerates, or aggregates dispersed uniformly throughout a continuous medium (commonly, a liquid). These particles can range in size from 0.001 μm to 1 μm or greater for “suspension” dispersions, or between 0.001 μm to 1 μm for “colloidal” dispersions.

As used herein, the term “emulsifier” includes the phrase “stabilizer” and refers to a substance that promotes uniform separation and distribution of droplets and/or particles throughout a continuous phase of an emulsion and/or a dispersion, as well as promotes the stability of the emulsion and/or dispersion, thereby preventing coalescence and/or settling out of the dispersed phase.

As used herein, a “biofilm” is a complex aggregate of microorganisms, such as bacteria, wherein the cells adhere to each other and/or to a surface. The cells in biofilms are physiologically distinct from planktonic cells of the same organism, which are single cells that can be motile in a liquid medium or on a solid medium.

As used herein, the terms “isolated” or “purified,” when used in connection with biological or natural materials such as nucleic acid molecules, polynucleotides, polypeptides, proteins, organic compounds, such as small molecules, microorganism cells/strains, or host cells, means the material is substantially free of other compounds, such as cellular material, with which it is associated in nature. That is, the materials do not occur naturally without these other compounds and/or have different or distinctive characteristics compared with those found in the native material.

In certain embodiments, purified compounds are at least 60% by weight the compound of interest. Preferably, the preparation is at least 75%, more preferably at least 90%, and most preferably at least 99% or 100% (w/w) of the desired compound by weight. Purity is measured by any appropriate standard method, for example, by column chromatography, thin layer chromatography, or high-performance liquid chromatography (HPLC) analysis.

In certain embodiments, the biological emulsifiers of the subject invention are characterized as “microbe-based compositions,” meaning a composition that comprises components that were produced as the result of the growth of microorganisms or other cell cultures. Thus, the microbe-based composition may comprise the microbes themselves and/or by-products of microbial growth (e.g., biosurfactants, solvents and/or enzymes). The cells may be in a vegetative state or in spore form, or a mixture of both. The cells may be planktonic or in a biofilm form, or a mixture of both.

The cells may be live or inactive, intact or lysed. The cells can be removed from the medium in which they were grown, or present at, for example, a concentration of at least 1×10³, 1×10⁴, 1×10⁵, 1×10⁶, 1×10⁷, 1×10⁸, 1×10⁹, 1×10¹⁰, or 1×10¹¹ or more cells per milliliter of the composition.

In one embodiment, the microbe-based composition may comprise only the medium in which the cells were grown, with the cells removed (although, in some instances, some residual cellular matter may also remain in the medium). The by-products of growth may be present in the medium and can include, for example, metabolites, cell membrane components, expressed proteins, and/or other cellular components. In one embodiment, the microbe-based composition comprises only microbial growth by-products.

In certain embodiments, the biological emulsifiers of the subject invention are characterized as “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, carriers, and other additives and/or adjuvants suitable for a particular application. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

A “metabolite” refers to any substance produced by metabolism (e.g., a growth by-product) or a substance necessary for taking part in a particular metabolic process. Examples of metabolites include, but are not limited to, enzymes, acids, solvents, alcohols, proteins, carbohydrates, vitamins, minerals, microelements, amino acids, polymers, and biosurfactants.

As used herein, “polymer” refers to any macromolecular compound prepared by bonding one or more similar molecular units, called monomers, together. Polymers include synthetic and biologically-synthesized polymers. Further included in the term polymer is the term “biopolymer” and “biological polymer,” which as used herein, means a natural polymeric substance, or a polymeric substance occurring in a living organism. One characteristic of biopolymers is their ability to biodegrade. Biopolymers can include polynucleotides (e.g., RNA and DNA), polysaccharides (e.g., linearly bonded polymeric carbohydrates), and polypeptides (i.e., short polymers of amino acids).

As used herein, “prevention” means avoiding, delaying, forestalling, or minimizing the onset or progression of a particular occurrence or situation (e.g., coalescence or settling out). Prevention can include, but does not require, absolute or complete prevention, meaning the occurrence or situation may still develop at a later time than it would without preventative measures. Prevention can include reducing the severity and/or extent of the onset of an occurrence or situation, and/or inhibiting the progression of the occurrence or situation to one that is more severe or extensive.

As used herein, “reduces” means a negative alteration, and “increases” means a positive alteration, wherein the alteration is at least 0.001%, 0.01%, 0.1%, 1%, 5%, 10%, 15%, 20%, 25%, 30%, 35%, 45%, 50%, 55%, 60%, 65%, 70%, 75%, 80%, 85%, 90%, 95%, 99%, or 100%, inclusive of all values therebetween.

As used herein, “surfactant” means a surface-active substance, or a compound that lowers the surface tension (or interfacial tension) between two phases. Surfactants act as, e.g., detergents, wetting agents, emulsifiers, foaming agents, and/or dispersants. By “biosurfactant” is meant a surface active agent produced by a living organism, and/or produced using naturally-derived substrates.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “an” and “the” are understood to be singular or plural.

Unless specifically stated or obvious from context, as used herein, the term “about” is understood as within a range of normal tolerance in the art, for example, within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

Other features and advantages of the invention will be apparent from the following description of the preferred embodiments thereof, and from the claims. All references cited herein are hereby incorporated by reference.

### Biological Emulsifiers and Methods of Producing Metalworking Fluids

In one embodiment, the subject invention provides biological emulsifiers comprising one or more microorganisms and/or one or more microbial growth by-products. In some embodiments, the emulsifier can serve a variety of additional purposes, including as a dispersant, detergent, biocide, and/or de-foamer.

Advantageously, in certain embodiments, the biological emulsifier facilitates the formation of MWF emulsions and/or dispersions, improves the stability of MWFs that are characterized as emulsions and/or dispersions, as well as prevents the demulsification and/or settling out of the dispersed ingredients, without negatively altering the function of the MWF.

In certain embodiments, the subject biological emulsifiers may comprise, for example, live and/or inactive microbial cells, fermentation medium, and/or microbial growth by-products. In one embodiment, the microbial growth by-products are separated from the microorganisms that produced them. The growth by-products can be in a purified or unpurified form. In some embodiments, the growth-products are further modified after extraction and optional purification.

In one embodiment, the microbial growth by-products are one or more biological emulsifying agents for use in formulation of MWFs. Preferably, the emulsifying agents are biosurfactants.

Advantageously, the biological emulsifying agents according to the subject composition are non-toxic, biodegradable, and do not emit polluting and/or hazardous substances into the environment. Additionally, in preferred embodiments, these compounds exhibit greater thermostability, halostability, and pH stability than chemical stabilizers, such as chemical surfactants. Furthermore, in certain embodiments, a lower dosage of the biological emulsifying agents is required for stabilizing the emulsion or dispersion than is required by chemical stabilizers.

Surface active agents according to the subject invention consist of two parts: a polar (hydrophilic) moiety and a non-polar (hydrophobic) moiety. Due to their structure, these molecules increase the surface area of hydrophobic water-insoluble substances, increase the water bioavailability of such substances, and accumulate at interfaces, thus reducing interfacial tension and leading to the formation of aggregated micellar structures in solution.

In certain embodiments, the biological emulsifier has a hydrophile-lipophile balance (HLB) value appropriate for the type of emulsion being formed. HLB is the balance of the size and strength of the hydrophilic and lipophilic moieties of a surface-active molecule. In water/oil and oil/water emulsions, the polar moiety of the surface-active molecule orients towards the water, and the non-polar group orients towards the oil, thus lowering the interfacial tension between the oil and water phases. Proper HLB is required for a stable emulsion to be formed.

HLB values range from 0 to 20, with lower HLB (e.g., 10 or less) being more oil-soluble and suitable for water-in-oil emulsions, and higher HLB (e.g., 10 or more) being more water-soluble and suitable for oil-in-water emulsions.

Surface active agents according to the subject invention include, for example, biosurfactants and/or biopolymers. These can include, for example, glycolipids, lipopeptides, flavolipids, phospholipids, fatty acid esters, and high-molecular-weight biopolymers such as lipoproteins, lipopolysaccharide-protein complexes, and/or polysaccharide-protein-fatty acid complexes.

In one embodiment, the surface active agents are glycolipids such as, for example, sophorolipids (SLP), rhamnolipids (RLP), cellobiose lipids, trehalose lipids or mannosylerythritol lipids (MEL). In one embodiment, the surface active agents are lipopeptides, such as, e.g., surfactin, iturin, fengycin, arthrofactin, viscosin and/or lichenysin. In one embodiment, the surface active agents are other types of amphiphilic molecules, such as, for example, esterified fatty acids, cardiolipins, pullulan emulsan, lipomanan, alasan, and/or liposan.

Other biologically-derived emulsifying agents, such as other biopolymers or polysaccharide-based substances (e.g., rubbers, starches, resins, gums, suberin, melanin, lignin, cellulose, xanthan gum, guar gum, welan gum, levan, xylinan, gellan gum, curdlan, pullulan, dextran, alginate), beta-glucans, mannoproteins, acids, solvents, enzymes, and/or proteins, can also be utilized according to the subject invention. These compounds are preferably derived from a living organism, including non-microbial organisms.

In some embodiments, the biological emulsifiers are utilized in a crude form, wherein a biosurfactant molecule is present in the growth medium (e.g., broth) in which a microorganism is cultivated and is collected therefrom without purification. The crude form can comprise, for example, at least 0.001%, 1%, 5%, 10%, 20%, 30%, 40%, 50%, 60%, 70%, 80%, 90% or 99% biological emulsifiers in the growth medium. In alternate embodiments, the biological emulsifiers are extracted from the growth medium and, optionally, derivatized and/or purified.

In certain embodiments of the present invention, sophorolipids (SLP) are specific glycolipids of interest. Sophorolipids are glycolipid biosurfactants produced by, for example, various yeasts of the Starmerella clade. SLP consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-A9-octadecenoic acid. The hydroxy fatty acid can have, for example, 11 to 20 carbon atoms, and may contain one or more unsaturated bonds. Furthermore, the sophorose residue can be acetylated on the 6- and/or 6′-position(s). The fatty acid carboxyl group can be free (acidic or linear form) or internally esterified at the 4″-position (lactonic form). In most cases, fermentation of SLP results in a mixture of hydrophobic (water-insoluble) SLP, including, e.g., lactonic SLP, mono-acetylated linear SLP and di-acetylated linear SLP, and hydrophilic (water-soluble) SLP, including, e.g., non-acetylated linear SLP.

As used herein, the term “sophorolipid,” “sophorolipid molecule,” “SLP” or “SLP molecule” includes all forms, and isomers thereof, of SLP molecules, including, for example, acidic (linear) SLP and lactonic SLP. Further included are mono-acetylated SLP, di-acetylated SLP, esterified SLP, SLP with varying hydrophobic chain lengths, SLP with fatty acid-amino acid complexes attached, and other, including those that are and/or are not described within in this disclosure.

In some embodiments, SLP molecules can be represented by General Formula (1) and/or General Formula (2), and are obtained as a collection of 30 or more types of structural homologues having different fatty acid chain lengths (R³), and, in some instances, having an acetylation or protonation at R¹ and/or R².

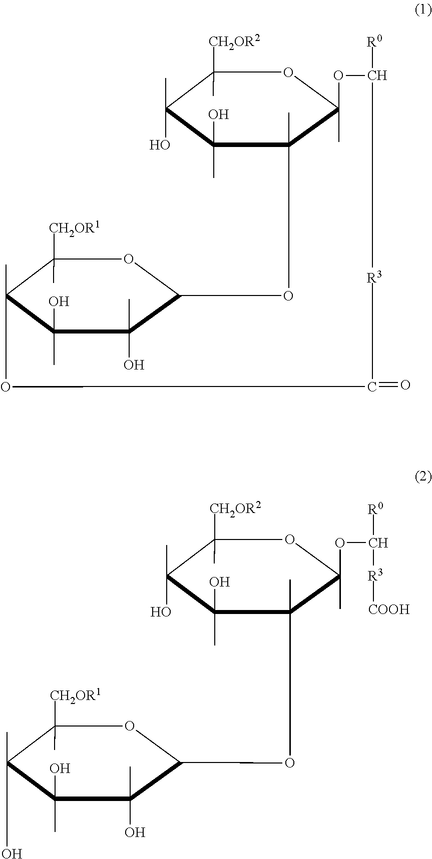

In General Formula (1) or (2), R⁴ can be either a hydrogen atom or a methyl group. R¹ and R² are each independently a hydrogen atom or an acetyl group. R³ is a saturated aliphatic hydrocarbon chain, or an unsaturated aliphatic hydrocarbon chain having at least one double bond, and may have one or more Substituents.

Non-limiting examples of the Substituents include halogen atoms, hydroxyl, lower (C1-6) alkyl groups, halo lower (C1-6) alkyl groups, hydroxy lower (C1-6) alkyl groups, halo lower (C1-6) alkoxy groups, and others, such as those that are described within the present disclosure. R³ can have, for example, 11 to 20 carbon atoms.

Fermentation of yeast cells in a culture substrate including a sugar and/or lipids and fatty acids with carbon chains of differing length can be used to produce a variety of SLP. The yeast Starmerella (Candida) bombicola is one of the most widely recognized producers of SLP. Typically, the yeast produces both lactonic and linear SLP during fermentation, with about 60-70% of the SLP comprising lactonic forms, and the remainder comprising lactonic forms.

In certain specific embodiments, the biosurfactant is a sophorolipid, or a mixture of SLP molecules comprising, for example, lactonic SLP, linear SLP, de-acetylated SLP, mono-acetylated SLP, di-acetylated SLP, esterified SLP, SLP with varying hydrophobic chain lengths, SLP with fatty acid-amino acid complexes attached, and others, including those that are and/or are not specifically exemplified within this disclosure.

In a specific preferred embodiment, the biosurfactant is a derivatized SLP, or a mixture of derivatized SLP, wherein the derivatized SLP comprises a linear or lactonic SLP modified to have improved stability at higher pH, higher temperature and/or higher pressure; enhanced de-foaming properties; and/or enhanced water or alcohol solubility over other SLP molecules.

In certain embodiments, the derivatized SLP comprises a cyclic ether analog of a lactonic SLP. Advantageously, reduction of the ester functionalities of an SLP to an ester linkage can enhance the stability of the lactone ring, thereby reducing pH instability as well as temperature and pressure sensitivity.

In certain embodiments, the derivatized SLP comprises a peracetylated hydrophilic portion. In certain embodiments, the hydrophilic portion comprises a silyl functional group.

In certain embodiments, the derivatized SLP comprises a fatty acid in which the carboxylic acid portion is transformed into, for example, a methyl, ethyl, or isobutyl ester. In certain embodiments, the fatty acid comprises amino acids that retain biological-based carbons while adding aromatic rings, such as, for example, phenylalanine methyl ester and/or tryptophan methyl ester.

In some embodiments, one or more of these modifications can alter the hydrophilicity and/or the HLB of the derivatized SLP to be more favorable for forming emulsions and/or for reducing foam.

In certain embodiments, the derivatized SLP has a formula according to General Formulas (3), (4), (5), (6) or (7):

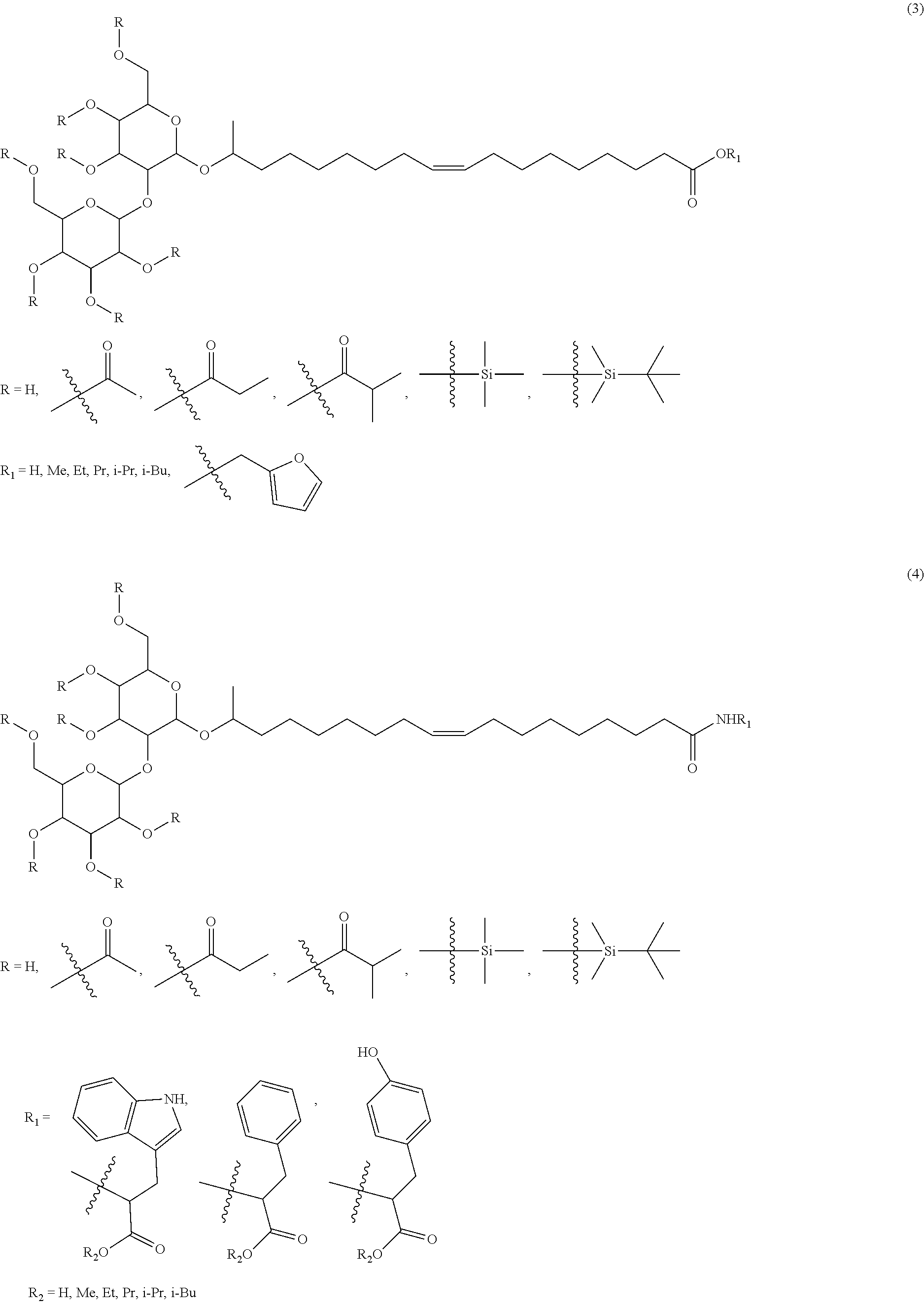

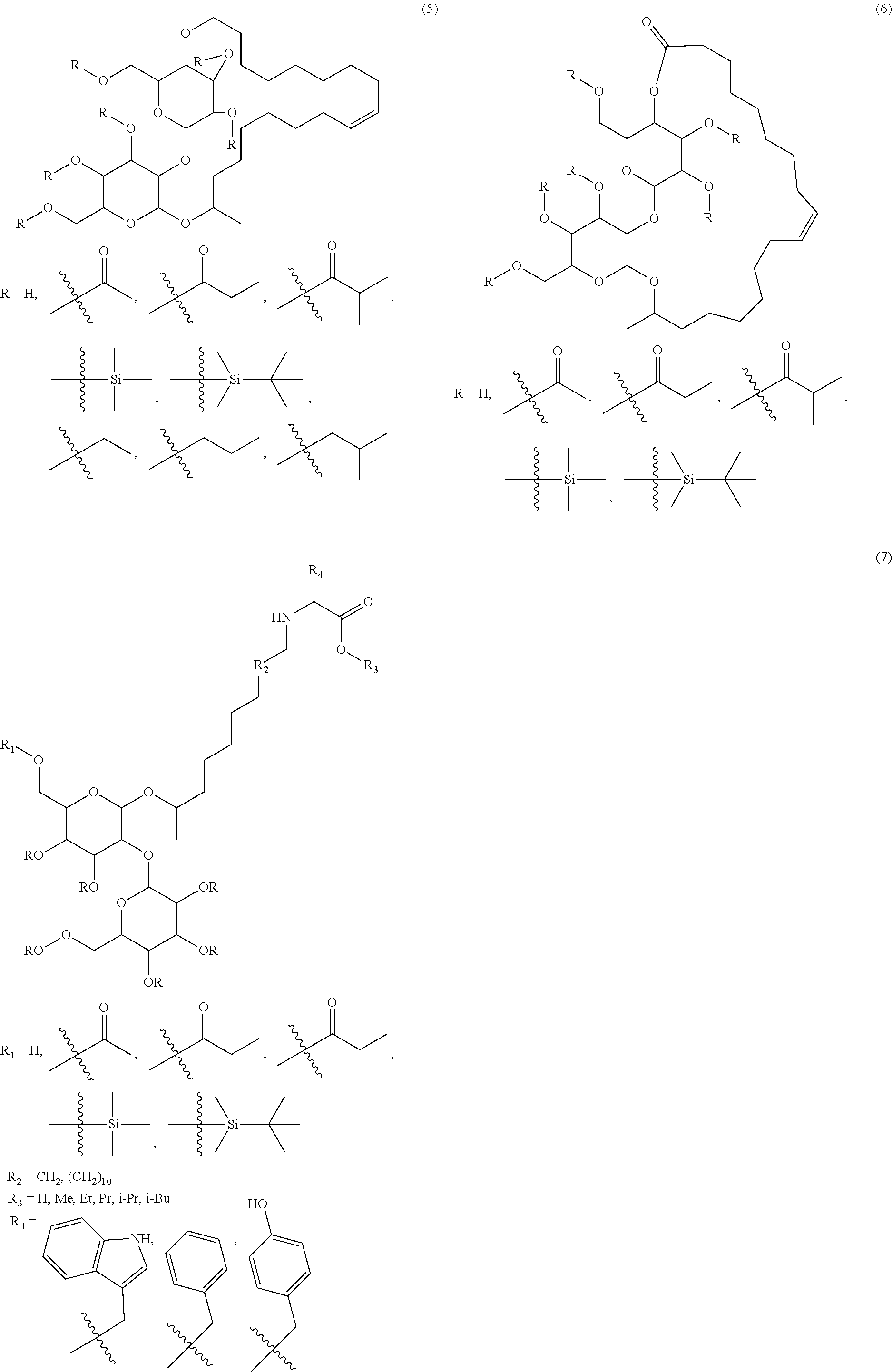

### Methods of Producing MWFs

In preferred embodiments, methods are provided for producing a stable MWF characterized as an emulsion and/or dispersion, wherein the methods comprise mixing two or more ingredients in the presence of a biological emulsifier of the subject invention.

As used herein, “stability” of an emulsion or dispersion refers to resistance to changes in the physiochemical properties of the emulsion or dispersion. In other words, stability is the emulsion or dispersion's ability to resist forces acting thereon that cause sedimentation (dispersed phase moves downward), creaming (dispersed phase moves upward), flocculation/aggregation of dispersed phase particles or droplets, coalescence of dispersed phase droplets or particles, and/or phase inversion (e.g., W/O becomes O/W).

In one embodiment, the two or more ingredients comprise a first ingredient and a second ingredient, wherein the first ingredient is dispersed in the second ingredient. Thus, in preferred embodiments, the first ingredient is characterized as the dispersed phase of the emulsion or dispersion, and the second ingredient is the continuous phase of the emulsion or dispersion.

In one embodiment, the first ingredient and the second ingredient are both liquids. Preferably, the two liquids, i.e., the first liquid and the second liquid, are not the same substance. In certain embodiments, the MWF is an O/W emulsion, wherein the first liquid is a lipid and/or an oil and the second ingredient is water or another aqueous fluid. In certain embodiments, the MWF is a W/O emulsion, wherein the first ingredient is water or another aqueous fluid and the second liquid is a lipid and/or an oil.

In some embodiments of the subject method, the biological emulsifier is first added to the second ingredient (continuous phase), followed by gradually adding the first ingredient (dispersed phase) to the second ingredient while actively mixing. In some embodiments, the biological emulsifier is added after the first and second ingredient have been contacted with one another, followed by mixing.

Preferably, mixing comprises vigorous agitation such that the dispersed phase is broken into small particles or droplets and dispersed uniformly throughout the continuous phase. The biological emulsifier coats the particles or droplets, thereby stabilizing the emulsion or dispersion.

In some embodiments, mixing is performed using, for example, a mill or a homogenizer machine. In some embodiments, mixing is performed by hand, using, for example, a whisk, blender or membrane emulsifier. In some embodiments, ultrasonic or supersonic mixing techniques are used, wherein, for example, a metal tool vibrates at a high frequency in the mixture to disrupt the dispersed phase into smaller particles or droplets.

In some embodiments, mixing is performed at room temperature, e.g., 20 to 25° C., or under mild, controlled heat, e.g., about 25 to 30° C. In certain embodiments, once formed, the MWF emulsion or dispersion is able to remain stable, even at widely varying temperatures.

Advantageously, the compositions and methods of the subject invention can be effective for enhancing the stability of MWFs without negatively altering their functionality.

In certain embodiments, addition of the biological emulsifier according to the subject methods serves to increase the amount of time the emulsion or dispersion is stable by, for example, at least 1 minute, 60 minutes, 1 day, 30 days, 1 month, 2 months, 3 months, 4 months, or longer.

In some embodiments, the methods can be implemented in combination with, or alongside, other methods of improving the quality of a MWF, as well as for improving the stability of MWF emulsions or dispersions. For example, additional ingredients, including solids, liquids and/or gases, as well as additional additives can also be included in the MWF.

In some embodiments, the subject method can be used to prevent spoilage of a MWF by contaminating microorganisms, such as bacteria and fungi, wherein the biosurfactant of the biological emulsifier has antimicrobial properties. In some embodiments, the subject method can be used for reducing foam produced during use of a MWF, wherein the biosurfactant of the biological emulsifier has foam inhibiting properties.

The methods of the subject invention can be implemented anywhere that MWFs are produced. The two or more ingredients and biological emulsifier can be stored in separate vessels onsite. When the need for the MWF arises, the ingredients and biological emulsifier can be collected and/or piped directly into one vessel and homogenized therein. In one embodiment, the method is implemented at or near a site (e.g., less than 300, 250, 200, 150, 100, 75, 50, 25, 15, 10, 5, 3, or 1 mile from the site) where MWFs are produced.

In one embodiment, the method can be implemented in a large-scale metalworking plant. In one embodiment, the method can be implemented in smaller-scale metalworking shop or by a hobbyist metalworker.

Advantageously, the compositions and methods of the subject invention utilize components that are biodegradable and toxicologically safe, and can serve as replacements for potentially harmful emulsifiers, such as, for example, ethoxylates. Thus, the present invention can be used for improving the quality of MWF emulsions or dispersions as a “green” additive, and, in some embodiments.

### Metalworking Fluids

In one embodiment, the subject invention provides MWFs produced according to the subject methods. Preferably, the MWFs are mixtures (e.g., emulsions and/or dispersions) comprising two or more ingredients, as well as a biological emulsifier of the subject invention. In certain embodiments, the MWF is characterized as a soluble oil or a semi-synthetic fluid.

In one embodiment, the two or more ingredients comprise a first ingredient and a second ingredient, wherein the first ingredient is dispersed in the second ingredient.

In one embodiment, the first ingredient and the second ingredient are both liquids. Preferably, the two liquids, i.e., the first liquid and the second liquid, are not the same substance.

In certain embodiments, the MWF is an O/W emulsion, wherein the first liquid is a lipid and/or an oil and the second ingredient is water or another aqueous fluid. In certain embodiments, the MWF is a W/O emulsion, wherein the first ingredient is water or another aqueous fluid and the second liquid is a lipid and/or an oil. In certain preferred embodiments, the oil is a mineral, animal, marine, plant or synthetic oil.

In certain embodiments, the percentage of oil with respect to the total amount of MWF is about 10% to 90%, about 20% to 80%, or about 25% to 75%.

In certain embodiments, the MWF comprises a biological emulsifier, e.g., a SLP of General Formulas (1)-(7), at a rate of about 100 ppm to about 250,000 ppm, about 200 ppm to about 100,000 ppm, about 300 ppm to about 75,000 ppm, about 400 ppm to about 50,000 ppm, or about 500 ppm to about 25,000 ppm.

Additional ingredients characterized as solids, liquids and/or gases, as well as, for example, buffers, stabilizers, anti-fog-additives, foam inhibitors, tensides, solubility enhancers, corrosion inhibitors, extreme-pressure-additives, and biocides (e.g., bactericides and fungicides), can also be included in the MWF, as can be determined by metalworker or chemist having the benefit of the subject disclosure.

1. A metalworking fluid (MWF) comprising a mixture of two or more ingredients and a biological emulsifier, said biological emulsifier comprising one or more biosurfactants, wherein at least one of the one or more biosurfactants is a sophorolipid (SLP).

2. The MWF of claim 1, wherein the SLP is a lactonic SLP, linear SLP, a derivatized lactonic SLP, a derivatized linear SLP, or a mixture of any of these.

3. The MWF of claim 1, characterized as an emulsion or a dispersion.

4. The MWF of claim 1, wherein the two or more ingredients comprise a first ingredient and a second ingredient, and wherein the first ingredient is dispersed in the second ingredient.

5. The MWF of claim 4, wherein the first ingredient is a first liquid and the second ingredient is a second liquid, said first liquid being different from said second liquid.

6. The MWF of claim 5, wherein the first liquid is a lipid and/or an oil, and the second ingredient is water or an aqueous fluid.

7. The MWF of claim 6, wherein the first liquid is a mineral oil, animal-based oil, plant-based oil, or synthetic oil.

8. The MWF of claim 1, further comprising an additional biosurfactant selected from glycolipids, lipopeptides, flavolipids, phospholipids, fatty acid esters, lipoproteins, lipopolysaccharide-protein complexes, and polysaccharide-protein-fatty acid complexes.

9. The MWF of claim 8, wherein the glycolipids are sophorolipids, rhamnolipids, trehalose lipids, cellobiose lipids and/or mannosylerythritol lipids.

10. The MWF of claim 8, wherein the lipopeptides are surfactin, iturin, fengycin, arthrofactin, viscosin and/or lichenysin.

11. The MWF of claim 1, further comprising additional ingredients selected from buffers, stabilizers, anti-fog-additives, foam inhibitors, tensides, solubility enhancers, corrosion inhibitors, extreme-pressure-additives, and biocides.

12. The MWF of claim 1, wherein the SLP is linear and has one of the following formulas:

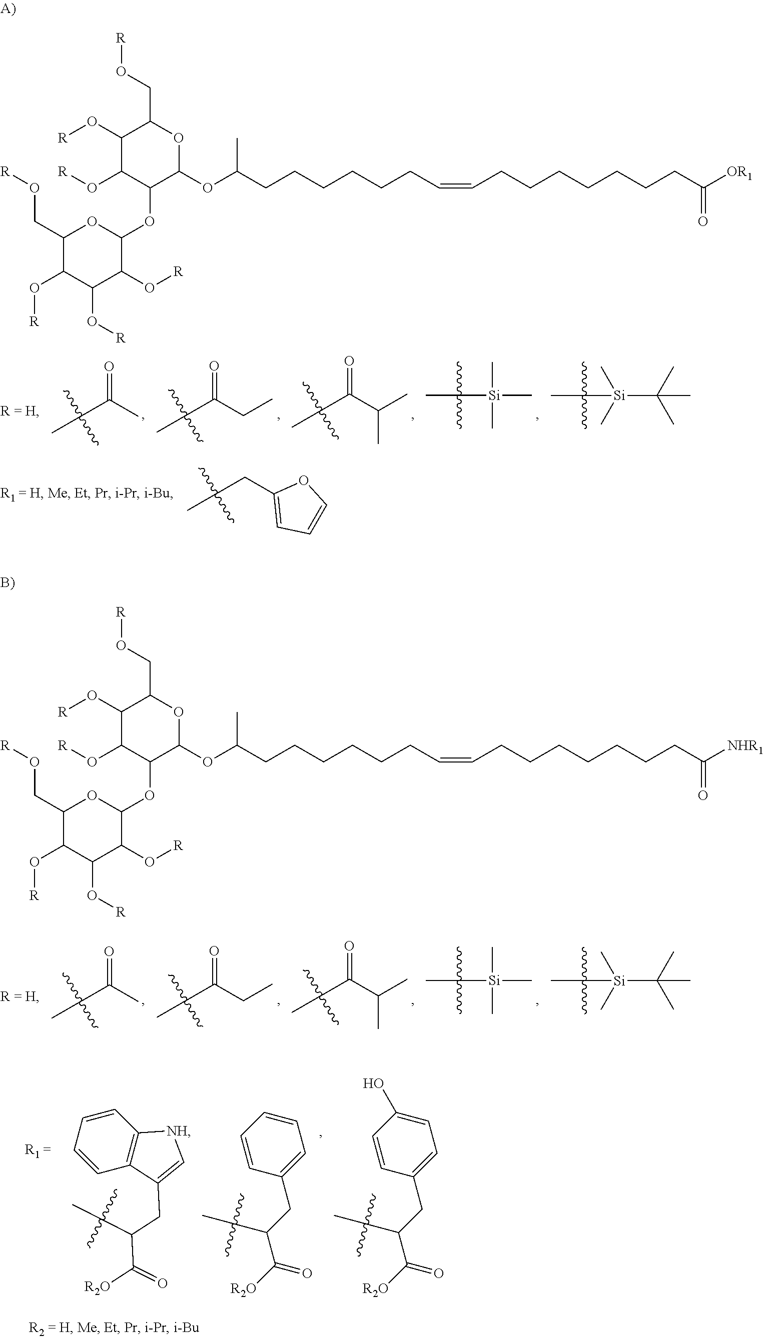

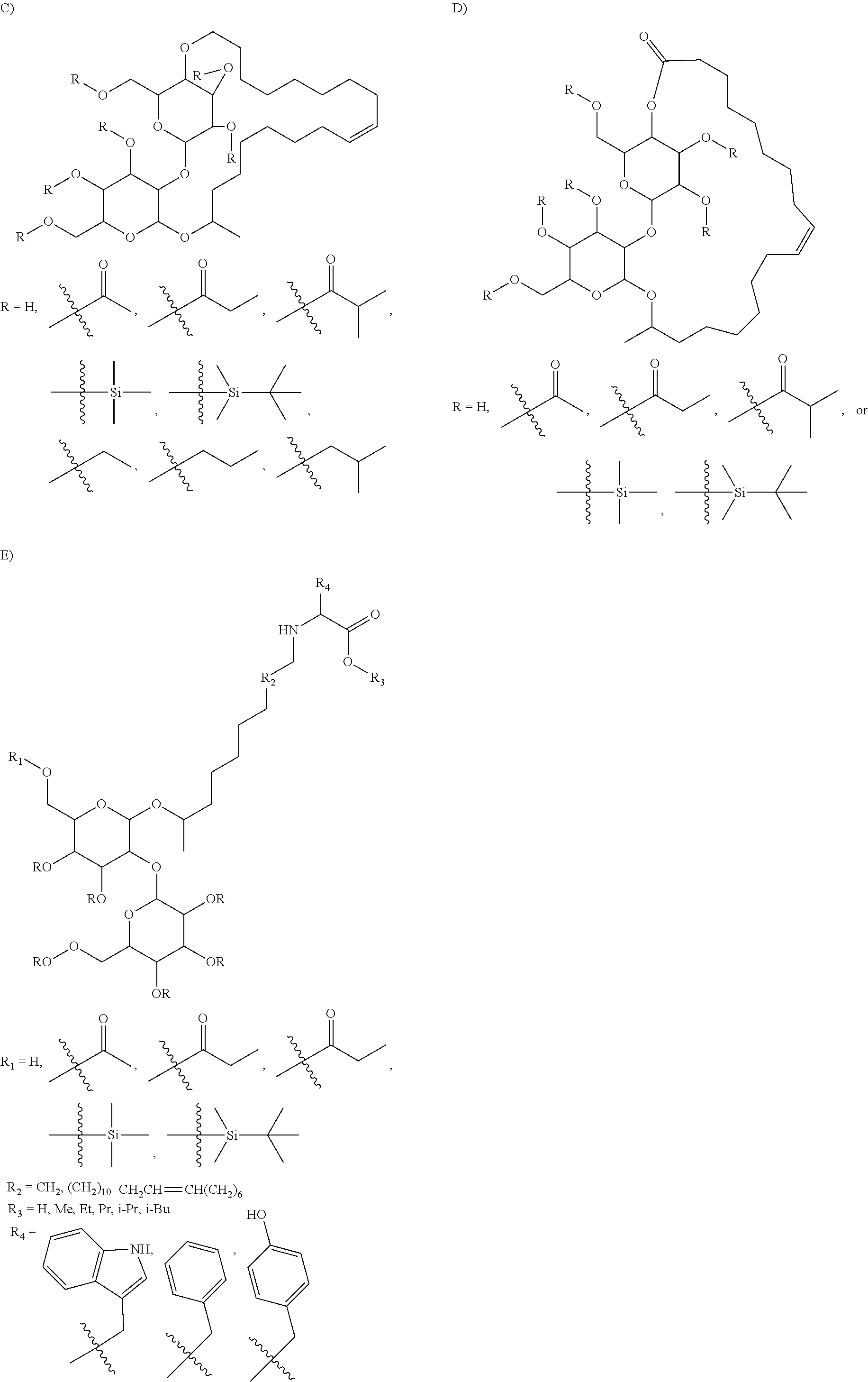

13. A method for producing a MWF characterized as an emulsion or dispersion, the method comprising mixing two or more ingredients in the presence of a biological emulsifier comprising one or more biosurfactants, wherein at least one of the one or more biosurfactants is a sophorolipid (SLP).

14. The method of claim 13, wherein the first ingredient is the dispersed phase of the emulsion or dispersion and the second ingredient is the continuous phase of the emulsion or dispersion.

15. The method of claim 13, wherein the first ingredient is a first liquid and the second ingredient is a second liquid.

16. The method of claim 13, wherein the first liquid is a lipid and/or an oil, and the second ingredient is water or an aqueous fluid.

17. The method of claim 16, wherein the oil is a mineral oil, animal-based oil, plant-based oil, or synthetic oil.

18. The method of claim 13, comprising first adding the biological emulsifier to the second ingredient, then gradually adding the first ingredient to the second ingredient while mixing.

19. The method of claim 13, comprising adding the biological emulsifier to a pre-mixture of the first and second ingredients while mixing.

20. The method of claim 13, wherein the mixing is performed using a mill, a homogenizer machine, a whisk, a blender, a membrane emulsifier or an ultrasonic mixing tool.
